(19) United States
(12) Patent Application Publication
(10) Pub. No.: US 2025/0131633 A1
(43) Pub. Date: Apr. 24, 2025

(54) AVATAR CONTROL DEVICE, AVATAR CONTROL METHOD, AND AVATAR CONTROL PROGRAM

(71) Applicant: JVCKENWOOD CORPORATION, Yokohama-shi (JP)

(72) Inventor: Tomoyuki SHISHIDO, Yokohama-shi (JP)

(21) Appl. No.: 19/006,094

(22) Filed: Dec. 30, 2024

Related U.S. Application Data
(63) Continuation of application No. PCT/JP2023/023545, filed on Jun. 26, 2023.

(30) Foreign Application Priority Data
Aug. 24, 2022 (JP) 2022-133533

(51) Int. Cl. G06T 13/40; G06F 3/01

(52) U.S. Cl. CPC G06T 13/40; G06F 3/011

(57) ABSTRACT

An avatar control method includes generating each avatar by drawing an avatar corresponding to each user. In addition, the avatar control method includes setting such that, when the number of the generated avatars is more than a predetermined number, motions of some of the users selected based on the number of other avatars looking at an avatar in question are not reflected on the avatars.

### CROSS-REFERENCE TO RELATED APPLICATIONS

This application is a continuation of PCT Application No. PCT/JP2023/023545, filed on Jun. 26, 2023, and claims the priority of Japanese Patent Application No. 2022-133533, filed on Aug. 24, 2022, the entire contents of both of which are incorporated herein by reference.

### BACKGROUND

The present disclosure relates to an avatar control device, an avatar control method, and an avatar control program.

In recent years, as the processing speed of a processor has increased, each user moves an avatar generated corresponding to each user, or interchanges avatars with each other in a virtual reality (VR) space (see Japanese Unexamined Patent Application Publication No. 2009-172239). Typically, a server for controlling an avatar, and a user terminal possessed by each user, communicate with each other via a network to generate an avatar corresponding to each user.

### SUMMARY

Although the processing speed of a processor has increased, the drawing load applied when drawing an avatar corresponding to each user may become excessive, or the communication load applied between a server and a user terminal may become excessive. Then, an avatar stops haphazardly, or is not able to follow a motion of a user. Accordingly, the motion of the avatar becomes unnatural, and the user feels a sense of discomfort.

A first aspect of one or more embodiments provides an avatar control method including: generating each avatar by drawing an avatar corresponding to each user; and setting such that, when the number of the generated avatars is more than a predetermined number, motions of some of the users selected based on the number of other avatars looking at an avatar in question are not reflected on the avatars.

A second aspect of one or more embodiments provides an avatar control method including: generating each avatar by drawing an avatar corresponding to each user; setting whether to reflect a motion of each user on the avatar; detecting an off-tracking state in which a motion detection signal corresponding to the motion of each user is no longer generated; holding specific posture data for causing the avatar to be in a stationary state or causing the avatar to make a specific motion in a specific posture data holding unit; among avatars corresponding to users in which the off-tracking state has been detected, setting an avatar in question who is looked at by a predetermined number or less of other avatars to be in the stationary state based on the specific posture data held in the specific posture data holding unit; and, among avatars corresponding to users in which the off-tracking state has been detected, setting an avatar in question who is looked at by more than the predetermined number of other avatars to make a specific motion based on the specific posture data held in the specific posture data holding unit.

A third aspect of one or more embodiments provides an avatar control method including: generating each avatar by drawing an avatar corresponding to each user; setting whether to reflect a motion of each user on the avatar; detecting an off-tracking state in which a motion detection signal corresponding to the motion of each user is no longer generated; holding specific posture data for causing the avatar to be in a stationary state or causing the avatar to make a specific motion in a specific posture data holding unit; among avatars corresponding to users in which the off-tracking state has been detected, setting an avatar whose motion immediately before detection of the off-tracking state is equal to or smaller than a predetermined magnitude to be in the stationary state based on the specific posture data held in the specific posture data holding unit; and among avatars corresponding to users in which the off-tracking state has been detected, setting an avatar whose motion immediately before the detection of the off-tracking state is larger than the predetermined magnitude to make the specific motion based on the specific posture data held in the specific posture data holding unit.

### BRIEF DESCRIPTION OF THE DRAWINGS

FIG. 1 is a block diagram illustrating an avatar control device according to a first embodiment.

FIG. 2 is a diagram illustrating an example of a motion of a user.

FIG. 3 is a diagram illustrating a skeletal motion when the user moves as shown in FIG. 2.

FIG. 4 is a schematic diagram illustrating a skeletal motion signal indicating the skeletal motion when the user moves as shown in FIG. 2.

FIG. 5 is a diagram illustrating a motion of an avatar when the user moves as shown in FIG. 2.

FIG. 6 is a schematic diagram illustrating the change in a skeletal motion signal when off-tracking occurs.

FIG. 7A is a diagram illustrating a state in which only one other avatar is looking at an avatar in question.

FIG. 7B is a diagram illustrating a state in which four other avatars are looking at an avatar in question.

FIG. 8 is a flowchart illustrating an operation performed by the avatar control device according to a first embodiment, an avatar control method according to a first embodiment, and processing that an avatar control program according to a first embodiment causes a computer to perform.

FIG. 9 is a block diagram illustrating an avatar control device according to a second embodiment.

FIG. 10 is a flowchart illustrating an operation performed by the avatar control device according to a second embodiment, an avatar control method according to a second embodiment, and processing that an avatar control program according to a second embodiment causes a computer to perform.

FIG. 11 is a flowchart illustrating an operation performed by an avatar control device according to a third embodiment, an avatar control method according to a third embodiment, and processing that an avatar control program according to a third embodiment causes a computer to perform.

### DETAILED DESCRIPTION

An avatar control device, an avatar control method, and an avatar control program according to each embodiment will be described below with reference to the accompanying drawings. The avatar control program is stored in a non-transitory computer readable medium.

### First Embodiment

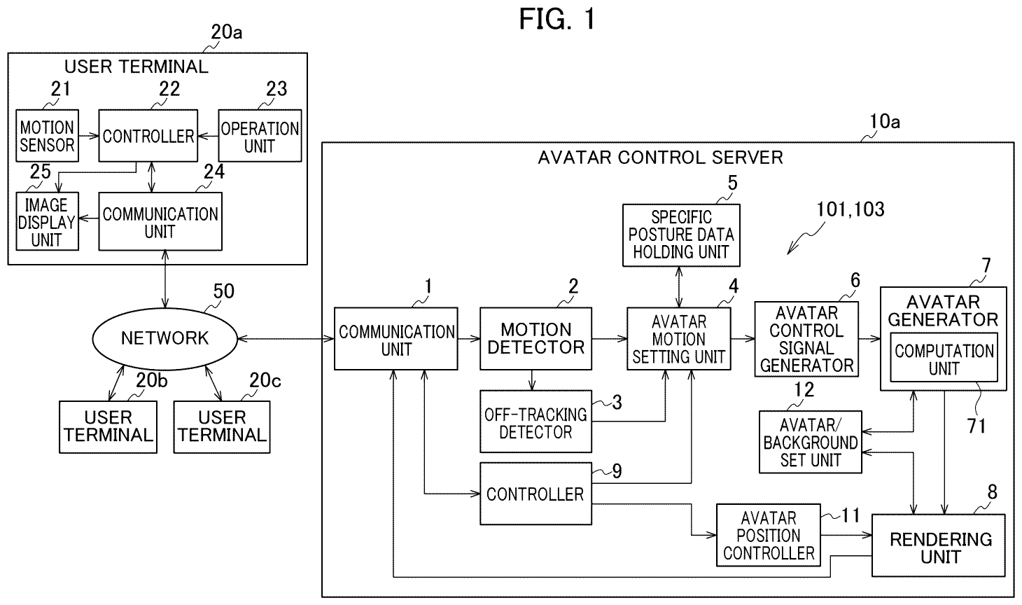

As shown in FIG. 1, an avatar control server 10a and user terminals 20a to 20c are connected via a network 50. Any one of the user terminals 20a to 20c, which is not specified, or any one of unillustrated other user terminals will be referred to as a user terminal 20. The number of the user terminals 20 connected to the avatar control server 10a via the network 50 is any number, such as one or more. Typically, the network 50 is the Internet.

The avatar control server 10a includes an avatar control device 101. The avatar control device 101 includes a communication unit 1, a motion detector 2, an off-tracking detector 3, an avatar motion setting unit 4, a specific posture data holding unit 5, an avatar control signal generator 6, an avatar generator 7, a rendering unit 8, a controller 9, an avatar position controller 11, and an avatar/background set unit 12. Each user terminal 20 includes a motion sensor 21, a controller 22, an operation unit 23, a communication unit 24, and an image display unit 25. The avatar generator 7 includes a computation unit 71.

The communication unit 1 can be constituted by a communication circuit which uses a communication protocol such as an Internet protocol to communicate with the user terminals 20. Each of units other than the communication unit 1 in the avatar control device 101 can be constituted by a computer including a processor and a memory. The specific posture data holding unit 5 and the avatar/background set unit 12 can be constituted by a computer memory. Each of units other than the communication unit 1, the specific posture data holding unit 5, and the avatar/background set unit 12 in the avatar control device 101 can be constituted by a computer processor.

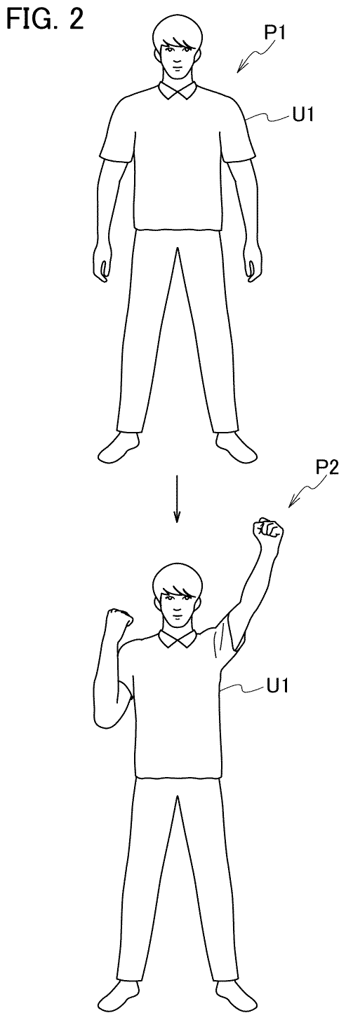

It is assumed that a user U1 shown in FIG. 2 possesses the user terminal 20a. The motion sensor 21 is a Time Of Flight (TOF) sensor, or a camera. When the motion sensor 21 is a TOF sensor, the motion sensor 21 measures a time required for light or an ultrasonic wave, which has been emitted to the user U1, to return. Then, the motion sensor 21 generates a motion detection signal corresponding to a motion (including a posture) of the user U1 indicating what posture the user U1 is in, or how the user U1 is moving.

The motion sensor 21 may be sensors such as acceleration sensors or gyro sensors attached to a plurality of portions of the user U1's body. It is sufficient if the motion sensor 21 can detect the motion or posture of the user U1's body, and the motion sensor 21 may be any sensor.

When the motion sensor 21 is a camera, the motion sensor 21 captures an image of the user U1, and generates a motion detection signal corresponding to a motion (including a posture) of the user U1. A camera used as the motion sensor 21 is a camera which captures an image of the user U1 two-dimensionally or a stereo camera which captures an image of the user U1 three-dimensionally. The use of a stereo camera as the motion sensor 21 is more preferable because the camera can capture an image of the user U1 three-dimensionally. The motion detection signal output from the motion sensor 21 is transmitted to the avatar control server 10a via the controller 22, the communication unit 24, and the network 50.

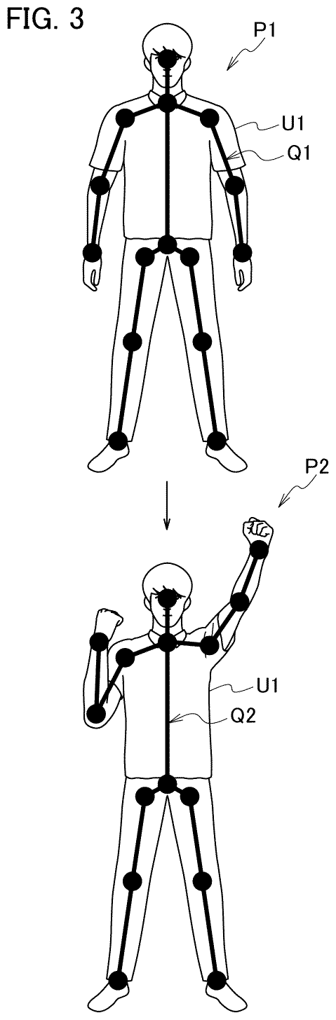

The communication unit 1, which has received the motion detection signal, supplies the signal to the motion detector 2. The motion detector 2 detects positions of a plurality of joints, and a position of a specific body part, of the user U1 based on the input motion detection signal. Then, the motion detector 2 generates a skeletal motion signal which indicates a skeletal motion of the user U1, and indicates what posture the user U1 is in and how the user U1 is moving. The skeletal motion signal is an example of a body motion signal indicating a body motion of the user U1. As shown in FIG. 2, it is assumed that a pose of the user U1 changes from a pose P1 in which the user is standing with both hands down to a pose P2 in which the user bends the right arm and raises the left arm upward. The motion detector 2 generates a skeletal motion signal including a skeletal posture Q1 corresponding to the pose P1, and a skeletal posture Q2 corresponding to the pose P2, as shown in FIG. 3.

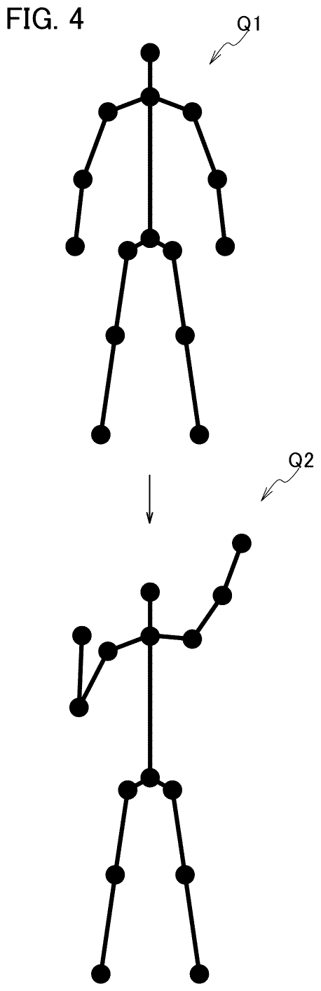

Although not shown in FIG. 3, the motion detector 2 generates a skeletal motion signal of a pose on the way from the pose P1 to the pose P2. A skeletal motion signal indicating the change from the skeletal posture Q1 to the skeletal posture Q2 shown in FIG. 4 is supplied to the off-tracking detector 3 and the avatar motion setting unit 4.

Each user terminal 20 may have a configuration corresponding to the motion detector 2. In this case, the communication unit 24 of each user terminal 20 transmits a skeletal motion signal of each user to the avatar control server 10a, and the communication unit 1 of the avatar control server 10a receives the skeletal motion signal. The received skeletal motion signal is supplied to the off-tracking detector 3 and the avatar motion setting unit 4.

When a skeletal motion signal is no longer input to the off-tracking detector 3, the off-tracking detector 3 detects that off-tracking has occurred. Off-tracking refers to a state in which the motion sensor 21 no longer generates a motion detection signal corresponding to a motion of the user U1. When the off-tracking detector 3 detects that off-tracking has occurred, the off-tracking detector 3 notifies the avatar motion setting unit 4 that off-tracking has occurred. The off-tracking detector 3 may also detect that off-tracking has occurred, when a skeletal motion signal indicates an unusual and abnormal motion. When a part of the user U1 body is at a position away from a TOF sensor, or at a position away from a camera, a skeletal motion signal may indicate an abnormal motion, for example.

If the avatar motion setting unit 4 is not notified that off-tracking has occurred, the avatar motion setting unit 4 instructs the avatar control signal generator 6 to cause an avatar to move according to the skeletal motion signal. The avatar control signal generator 6 generates an avatar control signal for controlling an avatar Av to move according to the skeletal motion signal, and supplies the signal to the avatar generator 7.

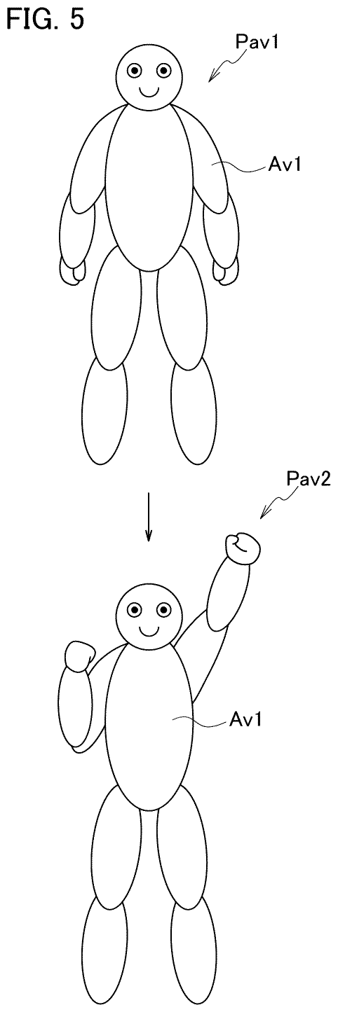

The computation unit 71 of the avatar generator 7 generates an avatar by drawing the avatar which moves according to the skeletal motion signal. Information on what form of avatar is generated by the avatar generator 7 is set in the avatar/background set unit 12. Assume that an avatar form set in the avatar/background set unit 12 is a form simulating a human body as shown in FIG. 5. The correspondence relationship indicating which part of an avatar corresponds to a human body part is also set in the avatar/background set unit 12.

Therefore, the avatar generator 7 generates an avatar Av1 shown in FIG. 5 that changes a pose from a pose Pav1 to a pose Pav2 in accordance with the change from the skeletal posture Q1 to the skeletal posture Q2 shown in FIG. 3. An arbitrary avatar including the avatar Av1 will be referred to as the avatar Av.

A user may upload a form of the avatar Av to the avatar/background set unit 12 using each user terminal 20. A plurality of forms of the avatar Av are set in the avatar/background set unit 12, and the user may select any of the forms.

Background data for determining a three-dimensional virtual space in which the avatar Av is positioned and moves is set in the avatar/background set unit 12. If the avatar Av is a two-dimensional image, the background data may be two-dimensional image data. The rendering unit 8 acquires background data from the avatar/background set unit 12, and performs rendering such that the avatar Av is positioned in a virtual space based on the background data.

The user can operate the operation unit 23 of each user terminal 20 to move the avatar Av in the virtual space. The controller 22 of each user terminal 20 generates a movement control signal for moving the avatar Av according to the operation performed using the operation unit 23. The movement control signal is transmitted to the avatar control server 10a via the communication unit 24 and the network 50. The communication unit 1 of the avatar control server 10a receives the movement control signal, and the controller 9 supplies the movement control signal to the avatar position controller 11. The avatar position controller 11 controls the rendering unit 8 such that the avatar Av in the virtual space moves according to the movement control signal.

As described above, the avatar control server 10a generates the avatar Av corresponding to the user of each user terminal 20, and generates a rendered image in which the avatar Av is positioned in the virtual space. The communication unit 1 transmits the rendered image to each user terminal 20. The communication unit 24 receives the rendered image, and the controller 22 controls the image display unit 25 to display the rendered image. The user can change a posture of the avatar Av, or move the avatar Av in the virtual space by changing the user's posture, while viewing the rendered image displayed on the image display unit 25.

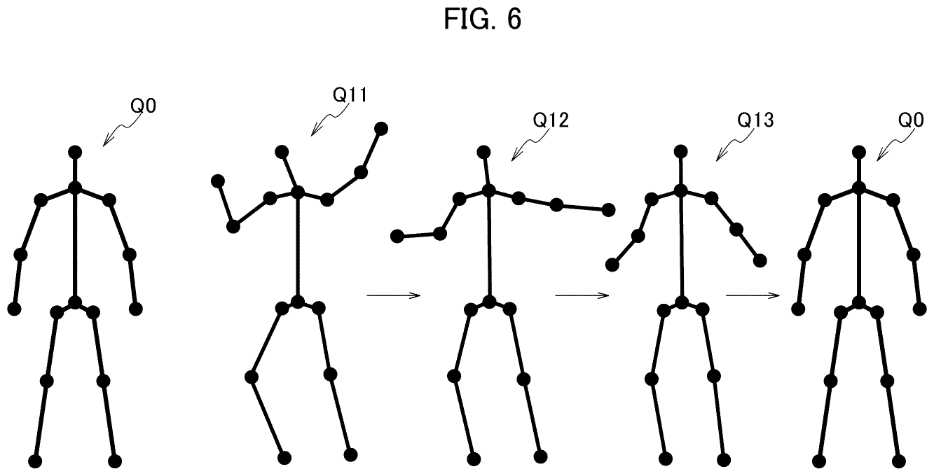

A description will be given regarding an operation performed by the avatar control server 10a, when the off-tracking detector 3 detects off-tracking. The specific posture data holding unit 5 holds specific posture data for causing the avatar Av to be in a stationary state, or causing the avatar Av to make a specific motion. As an example, the specific posture data holding unit 5 holds, as the specific posture data, posture data corresponding to a skeletal posture Q0 in a stationary state shown in FIG. 6. Here, the skeletal posture Q0 in the stationary state is the same as the skeletal posture Q1 shown in FIG. 4. The specific posture data for causing the avatar Av to make a specific motion may be posture data of a skeletal posture in which a part of the skeletal posture 00 changes periodically, for example.

When the motion detection unit 2 generates a skeletal motion signal corresponding to a skeletal posture Q11 shown in FIG. 6, it is assumed that off-tracking has occurred. The off-tracking detector 3 notifies the avatar motion setting unit 4 that off-tracking has occurred. Then, the avatar motion setting unit 4 instructs the avatar control signal generator 6 to change a posture of the avatar Av to a posture corresponding to the skeletal posture Q0 in the stationary state (or a skeletal posture of a specific motion), instead of changing a posture to the skeletal posture Q11 at the time of off-tracking. At this time, the motion detector 2 does not change a posture of the avatar directly from the skeletal posture Q11 to the skeletal posture Q0. It is preferable that the motion detector 2 changes the skeletal posture Q11 to a skeletal posture Q12, then to a skeletal posture Q13, and then to the skeletal posture Q0. The skeletal postures Q12 and the skeletal posture Q13 are skeletal postures present between the skeletal posture Q11 and the skeletal posture Q0.

For the avatar motion setting unit 4, it is possible to provide a user terminal 20 for controlling a posture to be the skeletal posture Q0 in the stationary state, and a user terminal 20 for controlling a posture to be the skeletal posture of the specific motion. Depending on whether an ID assigned to each user terminal 20 is an odd number or an even number, the avatar motion setting unit 4 may select the skeletal posture Q0 in the stationary state, or the skeletal posture of the specific motion. The avatar motion setting unit 4 may select the skeletal posture of the specific motion when the number of other avatars Av looking at an avatar Av in question is large (when the number is more than a predetermined number). The avatar motion setting unit 4 may select the skeletal posture Q0 in the stationary state, when the number of other avatars is small (when the number is the predetermined number or less).

The avatar motion setting unit 4 may select the skeletal posture of the specific motion, if the motion of the avatar Av immediately before the occurrence of the off-tracking is large (if the magnitude of the motion is larger than a predetermined magnitude). Alternatively, the avatar motion setting unit 4 may select the skeletal posture Q0 in the stationary state, if the motion is small (if the magnitude of the motion is the predetermined magnitude or less). The specific posture data holding unit 5 may hold specific posture data for causing the avatar to make a plurality of specific motions. The avatar motion setting unit 4 may select any of skeletal postures from the plurality of specific motions according to the motion of the avatar Av immediately before the occurrence of the off-tracking. The user may select the skeletal posture Q0 in the stationary state or the skeletal posture of the specific motion.

Incidentally, suppose that the number of the user terminals 20 connected to the avatar control server 10a via the network 50 becomes excessively large. In the above case, a drawing load applied when the avatar generator 7 draws an avatar Av corresponding to each user becomes excessive, and a communication load applied when communication is performed between the avatar control server 10a and each user terminal 20 becomes excessive. Therefore, in a first embodiment, in order to reduce the drawing load and the communication load, the avatar control device 101 is configured as follows.

The controller 9 acquires the number of user terminals 20 with which the communication unit 1 communicates. When the number of user terminals 20 connected to the avatar control server 10a is more than a predetermined number, the controller 9 transmits, to at least some of the user terminals 20, an instruction signal for instructing not to transmit a motion detection signal (or skeletal motion signal) to the avatar control server 10a. Each of the user terminals 20 which has received the instruction signal, and has been instructed not to transmit the motion detection signal to the avatar control server 10a, stops transmitting the motion detection signal to the avatar control server 10a. This reduces the communication load applied between the avatar control server 10a and each user terminal 20.

Further, each user terminal 20 which has stopped transmitting the motion detection signal to the avatar control server 10a is in the above-described off-tracking state in the avatar control device 101. The avatar Av corresponding to a user of each user terminal 20 which has stopped transmitting the motion detection signal to the avatar control server 10a is in a stationary state, or makes only a specific motion. This reduces the drawing load applied to the avatar generator 7.

The controller 9 may select user terminals 20 which will be instructed by the controller 9 not to transmit the motion detection signal to the avatar control server 10a as follows. As a first example, the controller 9 selects user terminals 20 which will be instructed by the controller 9 not to transmit the motion detection signal to the avatar control server 10a, based on IDs assigned to the user terminals 20. Depending on whether the IDs are odd numbers or even numbers, the controller 9 divides the user terminals 20 into two groups, for example. The controller 9 instructs user terminals 20 in one group not to transmit the motion detection signal to the avatar control server 10a.

As a second example, the controller 9 selects, as the user terminal 20 which will be instructed by the controller 9 not to transmit the motion detection signal to the avatar control server 10a, the user terminal 20 of a user corresponding to the avatar Av in question as one of any avatars Av that is looked at by a small number of other avatars Av. The controller 9 comprehends a position of each avatar Av in the virtual space and a direction in which each avatar Av faces. A field of view of each avatar Av is set in advance.

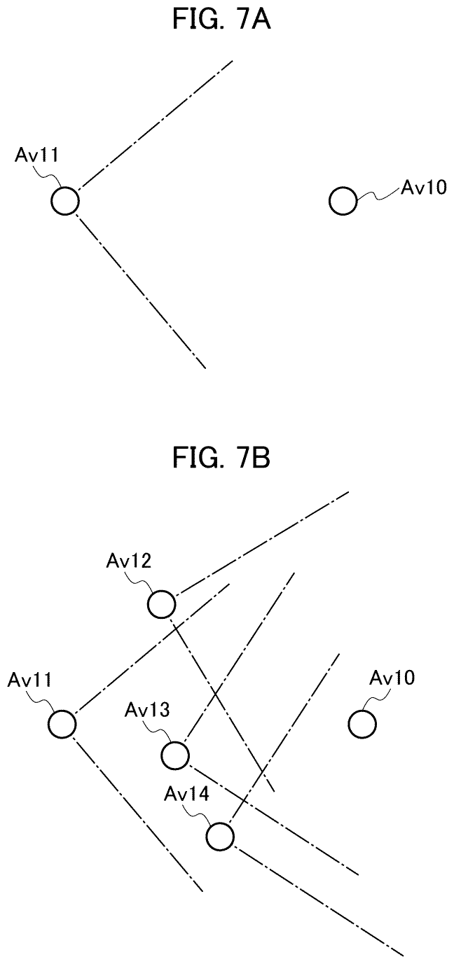

FIG. 7A shows a state in which only one other avatar Av, which is an avatar Av11, is looking at an avatar Av10 in question. FIG. 7B shows a state in which four other avatars Av, which are avatars Av11 to Av14, are looking at the avatar Av10 in question. In FIGS. 7A and 7B, a predetermined angle range indicated by a one-dot chain line represents a field of view of each avatar Av. Comparing FIG. 7A and FIG. 7B where the number of other avatars Av is large, when the moving avatar Av10 in question is suddenly in the stationary state, users corresponding to other avatars Av in FIG. 7B feel a stronger sense of discomfort than the user in FIG. 7A.

The controller 9 most preferentially selects the user terminal 20 of a user corresponding to the avatar Av10 in question as one of any avatars Av who is not looked at by any avatar Av, as the user terminals 20 which will be instructed by the controller 9 not to transmit the motion detection signal to the avatar control server 10a. When the number of user terminals 20, from which the selected user terminal 20 has been excluded, and which are connected to the avatar control server 10a is still larger than the predetermined number, the controller 9 selects the user terminal 20 of a user corresponding to the avatar Av10 in question as one of any avatars Av who is looked at by a smaller number of other avatars Av.

The controller 9 may select the user terminal 20 which will be instructed by the controller 9 not to transmit the motion detection signal to the avatar control server 10a, until the number of user terminals 20, from which the selected user terminal 20 has been excluded, and which are connected to the avatar control server 10a, is the predetermined number or less.

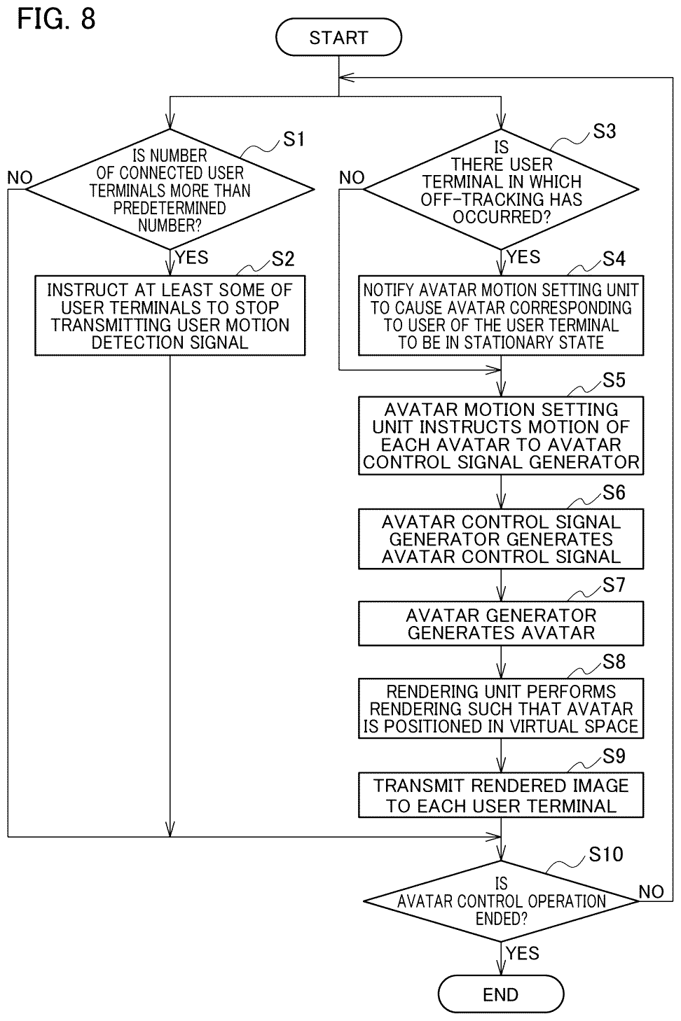

With reference to a flowchart shown in FIG. 8, a description will be given regarding an operation performed by the avatar control device 101 according to a first embodiment, an avatar control method according to a first embodiment, and processing that an avatar control program according to a first embodiment causes a computer to perform. After the start of processing by the avatar control device 101 in FIG. 8, in step S1, the controller 9 determines whether the number of connected user terminals 20 is more than a predetermined number. If the number of the user terminals 20 is more than the predetermined number (YES), in step S2, the controller 9 instructs at least some of the user terminals 20 to stop transmitting a user motion detection signal, and the processing proceeds to step S10. If the number of the user terminals 20 is the predetermined number or less (NO), the processing proceeds to step S10 by the controller 9.

In parallel with step S1, in step S3, the off-tracking detector 3 determines whether there is a user terminal in which off-tracking has occurred. If there is a user terminal 20 in which the off-tracking has occurred (YES), in step S4, the off-tracking detector 3 notifies the avatar motion setting unit 4 to cause an avatar corresponding to a user of the user terminal 20 to be in a stationary state. Following step S4, or if there is no user terminal 20 in which off-tracking has occurred in step S3 (NO), in step S5, the avatar motion setting unit 4 instructs a motion of each avatar Av to the avatar control signal generator 6.

In step S6, the avatar control signal generator 6 generates an avatar control signal. In step S7, the avatar generator 7 generates the avatar Av. In step S8, the rendering unit 8 performs rendering such that the avatar Av is positioned in a virtual space. In step S9, the communication unit 1 transmits a rendered image to each user terminal 20.

In step S10, the avatar control device 101 determines whether to end an avatar control operation. If the avatar control operation does not end (NO), the avatar control device 101 returns the processing to steps S1 and S3 to repeat the processing of the steps and thereafter. If the avatar control operation ends (YES), the avatar control device 101 ends the processing.

As described above, the avatar control device 101 according to a first embodiment includes the avatar generator 7 that generates each avatar by drawing the avatar Av corresponding to each user, and the avatar motion setting unit 4 that sets whether to reflect motions of at least some of users on avatars Av generated by the avatar generator 7 according to the number of the avatars Av. The avatar control method and the avatar control program according to a first embodiment are used for generating each avatar by drawing the avatar Av corresponding to each user, and setting whether to reflect motions of at least some users on generated avatars Av according to the number of the avatars Av.

Therefore, in accordance with the avatar control device 101, the avatar control method, and the avatar control program according to a first embodiment, it is possible to perform control so as to generate the avatar Av corresponding to each user, while preventing the drawing load or the communication load from becoming excessive.

It is preferable that the avatar motion setting unit 4 sets the avatar Av, on which motion of a user is not reflected, to be in a stationary state, or to make a specific motion.

The avatar control device 101 according to a first embodiment is disposed in the avatar control server 10a which is connected to each user terminal 20 via the network 50. Each user terminal 20 transmits, to the avatar control server 10a, a motion detection signal generated by the motion sensor 21 for detecting a motion of each user, or a skeletal motion signal of each user generated based on the motion detection signal.

The avatar control device 101 acquires the number of user terminals 20 connected to the avatar control server 10a. The avatar control device 101 includes the controller 9 which instructs at least some of the user terminals 20 not to transmit a motion detection signal or a skeletal motion signal to the avatar control server 10a, when the number of the user terminals 20 connected to the avatar control server 10a is more than the predetermined number. Therefore, it is possible to implement the avatar control device 101 which prevents the drawing load or the communication load from becoming excessive.

### Second Embodiment

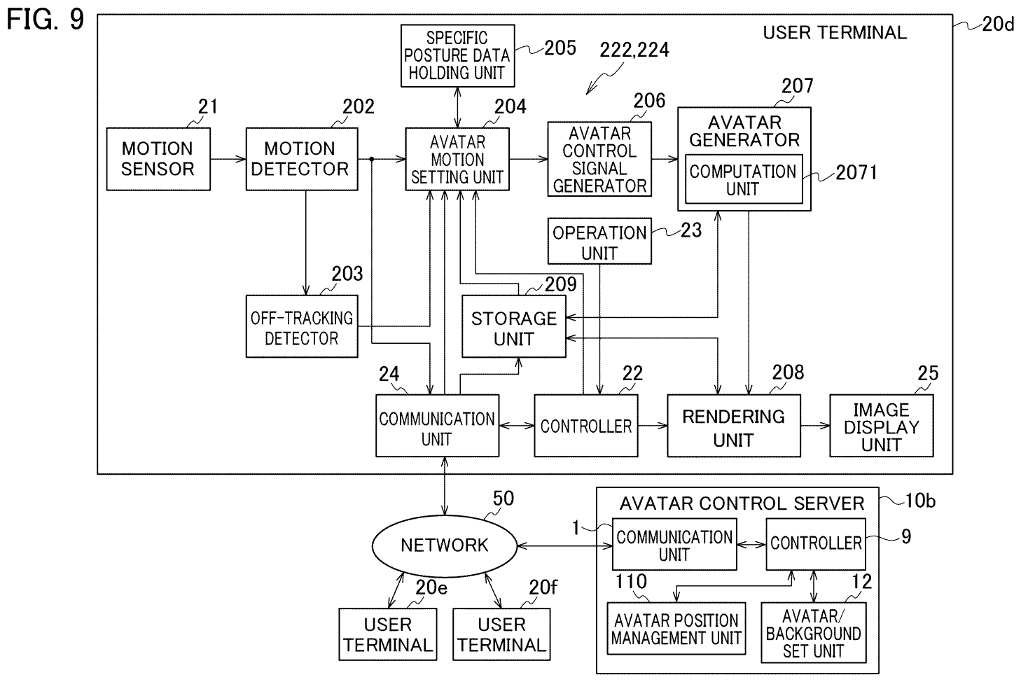

In a second embodiment shown in FIG. 9, parts which are the same as those in a first embodiment are denoted by the same reference numerals, and a description thereof may be omitted. As shown in FIG. 9, an avatar control server 10b and user terminals 20d to 20f are connected via the network 50. Any one of the user terminals 20d to 20f, which is not specified, or any one of unillustrated other user terminals will be referred to as a user terminal 20. The number of the user terminals 20 connected to the avatar control server 10b via the network 50 is any number, such as one or more.

Each user terminal 20 includes an avatar control device 222. As configurations different from those of each user terminal 20 in a first embodiment, each user terminal 20 in a second embodiment includes a motion detector 202, an off-tracking detector 203, an avatar motion setting unit 204, a specific posture data holding unit 205, an avatar control signal generator 206, an avatar generator 207, a rendering unit 208, and a storage unit 209. The avatar generator 207 includes a computation unit 2071. The avatar control server 10b includes the communication unit 1, the controller 9, the avatar/background set unit 12, and an avatar position management unit 110.

The avatar control device 222 can be constituted by a computer including a processor and a memory. The specific posture data holding unit 205 and the storage unit 209 can be constituted by a computer memory. Each of units other than the motion sensor 21, the operation unit 23, the communication unit 24, the image display unit 25, the specific posture data holding unit 205, and the storage unit 209 in the avatar control device 222 can be constituted by a computer processor.

Similarly to the motion detector 2, the motion detector 202 generates a skeletal motion signal of each user. The skeletal motion signal is supplied to the off-tracking detector 203, the avatar motion setting unit 204, and the communication unit 24. The communication unit 24 transmits the skeletal motion signal to the avatar control server 10b. The communication unit 1 in the avatar control server 10b receives a skeletal motion signal transmitted from each user terminal 20. The communication unit 1 transmits skeletal motion signals transmitted from all other user terminals 20 to each user terminal 20 under the control by the controller 9.

In an example shown in FIG. 9, the communication unit 1 transmits skeletal motion signals received from the user terminals 20e and 20f to the user terminal 20d. The communication unit 1 transmits skeletal motion signals received from the user terminals 20d and 20f to the user terminal 20e. The communication unit 1 transmits skeletal motion signals received from the user terminals 20d and 20e to the user terminal 20f.

The off-tracking detector 203 detects whether off-tracking has occurred in each user terminal 20, based on a skeletal motion signal supplied from the motion detector 202 in the user terminal 20 in question, and a skeletal motion signal generated by the motion detector 202 in another user terminal 20. When the off-tracking detector 203 detects that off-tracking has occurred in any of the user terminals 20, the off-tracking detector 203 notifies the avatar motion setting unit 204 that off-tracking has occurred.

If the avatar motion setting unit 204 is not notified that off-tracking has occurred, the avatar motion setting unit 204 instructs the avatar control signal generator 206 to cause the avatar Av to move according to the skeletal motion signal. The avatar control signal generator 206 generates an avatar control signal for controlling the avatar Av to move according to the skeletal motion signal, and supplies the signal to the avatar generator 207. The computation unit 2071 of the avatar generator 207 generates the avatar Av by drawing the avatar Av which moves according to the skeletal motion signal.

Information indicating the avatar Av form, information indicating the correspondence relationship indicating which part of the avatar Av corresponds to a human body part, and background data, which are set in the avatar/background set unit 12 of the avatar control server 10b, are transmitted to each user terminal 20 and are stored in the storage unit 209. The rendering unit 8 acquires the background data from the storage unit 209, and performs rendering such that the avatar Av is positioned in a virtual space based on the background data.

The controller 22 of each user terminal 20 generates a movement control signal for moving the avatar Av according to an operation performed using the operation unit 23. The controller 22 controls the rendering unit 208 such that the avatar Av corresponding to a user of the user terminal 20 in question moves according to the movement control signal in the virtual space. The movement control signal is transmitted to the avatar control server 10b. The avatar position management unit 110 acquires movement control signals from all of the user terminals 20, and manages a position of each avatar Av in the virtual space.

The communication unit 1 transmits movement control signals transmitted from all other user terminals 20 to each user terminal 20 under control by the controller 9. In the example shown in FIG. 9, the communication unit 1 transmits movement control signals received from the user terminals 20e and 20f to the user terminal 20d. The communication unit 1 transmits movement control signals received from the user terminals 20d and 20f to the user terminal 20e. The communication unit 1 transmits movement control signals received from the user terminals 20d and 20e to the user terminal 20f. The controller 22 controls the rendering unit 208 such that an avatar Av corresponding to a user of another user terminal 20 moves according to a movement control signal in the virtual space.

The image display unit 25 displays a rendered image generated by the rendering unit 208. A user can change a posture of the avatar Av, or move the avatar Av in the virtual space by changing the user's posture, while viewing the rendered image displayed on the image display unit 25.

The specific posture data holding unit 205 holds specific posture data for causing the avatar Av to be in a stationary state, or causing the avatar Av to make a specific motion. An operation performed by the avatar motion setting unit 204 when the off-tracking detector 203 detects the off-tracking is the same as the operation performed by the avatar motion setting unit 4.

In a second embodiment, in order to reduce the drawing load and the communication load, the avatar control server 10b is configured as follows. The controller 9 acquires the number of user terminals 20 which are connected to the avatar control server 10b, and with which the communication unit 1 communicates. When the number of user terminals 20 connected to the avatar control server 10b is more than a predetermined number, the controller 9 transmits, to at least some of the user terminals 20, an instruction signal for instructing not to transmit a skeletal motion signal to the avatar control server 10b. Each of the user terminals 20 which has received the instruction signal, and has been instructed not to transmit the skeletal motion signal to the avatar control server 10b, stops transmitting the skeletal motion signal to the avatar control server 10b. This reduces the communication load applied between the avatar control server 10b and each user terminal 20.

Further, the avatar Av corresponding to the user of each user terminal 20 which has stopped transmitting the skeletal motion signal to the avatar control server 10b is in an off-tracking state in another user terminal 20. The avatar Av corresponding to the user of each user terminal 20 which has stopped transmitting the skeletal motion signal to the avatar control server 10b is in a stationary state, or makes only a specific motion. This reduces the drawing load applied to the avatar generator 207.

The way the controller 9 selects a user terminal 20 which will be instructed by the controller 9 not to transmit the skeletal motion signal to the avatar control server 10b may be the same as the way the controller 9 selects the user terminal 20 which will be instructed by the controller 9 not to transmit the motion detection signal to the avatar control server 10a in a first embodiment.

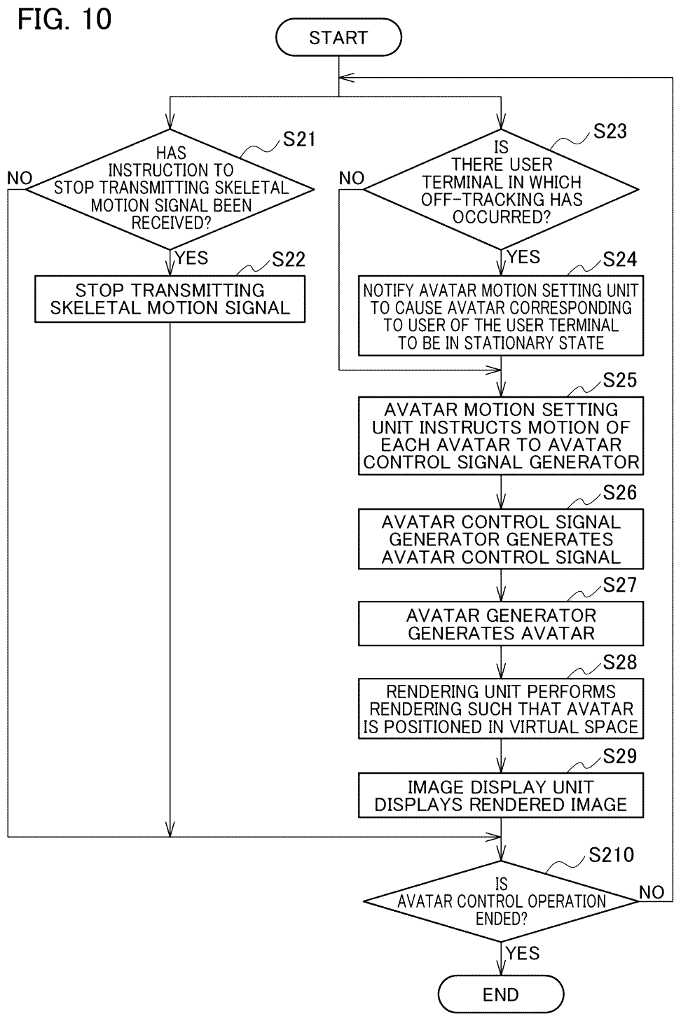

With reference to a flowchart shown in FIG. 10, a description will be given regarding an operation performed by the avatar control device 222 according to a second embodiment, an avatar control method according to a second embodiment, and processing that an avatar control program according to a second embodiment causes a computer to perform. After the start of processing by the avatar control device 222 in FIG. 10, in step S21, the controller 22 determines whether an instruction to stop transmitting a skeletal motion signal has been received. If the instruction to stop transmitting the skeletal motion signal has been received (YES), in step S22, the communication unit 24 stops transmitting the skeletal motion signal, and the processing proceeds to step S210 by the controller 22. Alternatively, if the instruction to stop transmitting the skeletal motion signal has not been received (NO), the processing proceeds to step S210 by the controller 22.

In parallel with step S21, in step S23, the off-tracking detector 203 determines whether there is a user terminal in which off-tracking has occurred. If there is a user terminal 20 in which off-tracking has occurred (YES), in step S24, the off-tracking detector 203 notifies the avatar motion setting unit 204 to cause an avatar corresponding to a user of the user terminal 20 to be in a stationary state. Following step S24, or if there is no user terminal 20 in which off-tracking has occurred in step S23 (NO), in step S25, the avatar motion setting unit 204 instructs a motion of each avatar Av to the avatar control signal generator 206.

In step S26, the avatar control signal generator 206 generates an avatar control signal. In step S27, the avatar generator 207 generates the avatar Av. In step S28, the rendering unit 208 performs rendering such that the avatar Av is positioned in a virtual space. In step S29, the image display unit 25 displays a rendered image.

In step S210, the avatar control device 222 determines whether to end an avatar control operation. If the avatar control operation does not end (NO), the avatar control device 222 returns the processing to steps S21 and S23 to repeat the processing of the steps and thereafter. If the avatar control operation ends (YES), the avatar control device 222 ends the processing.

As described above, the avatar control device 222 according to a second embodiment includes the avatar generator 207 which generates each avatar by drawing the avatar Av corresponding to each user, and the avatar motion setting unit 204 which sets whether to reflect motions of at least some users on avatars Av generated by the avatar generator 207 according to the number of the avatars Av. The avatar control method and the avatar control program according to a second embodiment are used for generating each avatar by drawing an avatar Av corresponding to each user, and setting whether to reflect motions of at least some users on generated avatars Av according to the number of the avatars Av.

Therefore, in accordance with the avatar control device 222, the avatar control method, and the avatar control program according to a second embodiment, it is possible to perform control so as to generate an avatar Av corresponding to each user, while preventing the drawing load or the communication load from becoming excessive.

It is preferable that the avatar motion setting unit 204 sets the avatar Av, on which a motion of a user is not reflected, to be in a stationary state or to make a specific motion.

The avatar control device 222 according to a second embodiment is disposed in each user terminal 20. Each user terminal 20 transmits, to the avatar control server 10b, a skeletal motion signal of each user generated based on a motion detection signal which is generated by the motion sensor 21 for acquiring a motion of each user. The avatar control device 222 in each user terminal 20 acquires, from the avatar control server 10b, a skeletal motion signal generated by another user terminal 20 other than a user terminal 20 in question.

When the number of user terminals 20 connected to the avatar control server 10b is more than a predetermined number, the avatar control server 10b transmits, to at least some of user terminals 20, an instruction signal for instructing not to transmit the skeletal motion signal to the avatar control server 10b. Therefore, the avatar control device 222 in at least some of the user terminals 20 acquires the instruction signal transmitted from the avatar control server 10b.

The avatar control device 222 includes the controller 22 which performs control to prevent the skeletal motion signal from being transmitted to the avatar control server 10b, after receiving the instruction signal. Therefore, according to a second embodiment, it is possible to implement the avatar control device 222 which prevents the drawing load or the communication load from becoming excessive.

### Third Embodiment

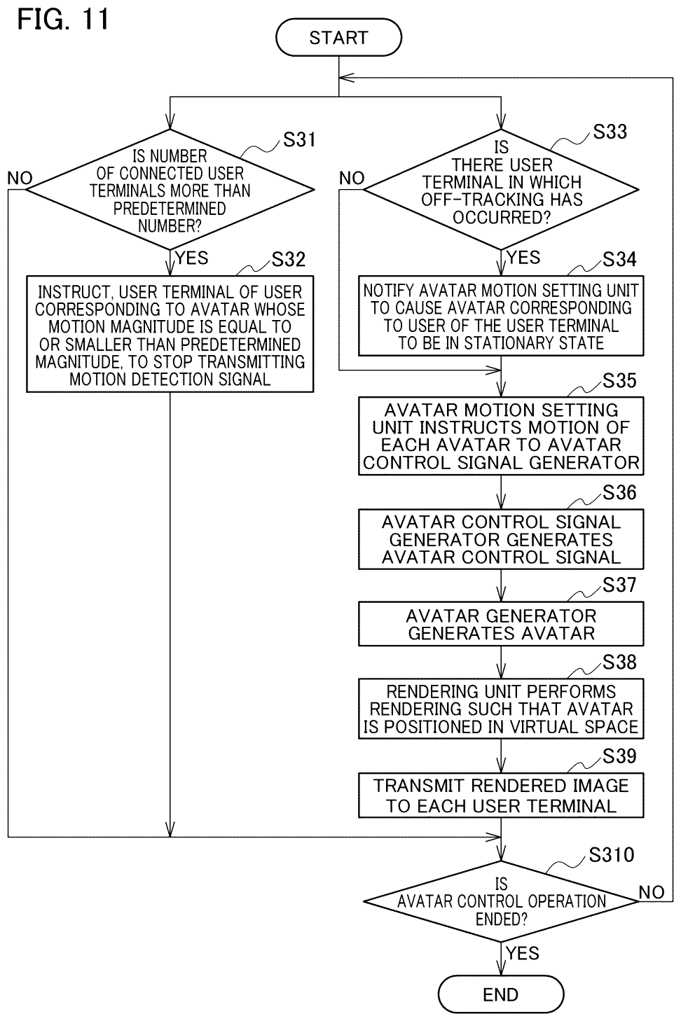

As shown in FIG. 1, the avatar control server 10a includes an avatar control device 103 according to a third embodiment having the same configuration as the avatar control device 101. With reference to a flowchart shown in FIG. 11, a description will be given regarding an operation performed by the avatar control device 103 according to a third embodiment, an avatar control method according to a third embodiment, and processing that an avatar control program according to a third embodiment causes a computer to perform.

After the start of processing by the avatar control device 103 in FIG. 11, in step S31, the controller 9 determines whether the number of connected user terminals 20 is more than a predetermined number. If the number of the user terminals 20 is more than the predetermined number (YES), in step S32, the controller 9 instructs the user terminal 20 of a user corresponding to an avatar whose motion magnitude is equal to or smaller than a predetermined magnitude, to stop transmitting a motion detection signal. Then, the processing proceeds to step S310. If the number of the user terminals 20 is the predetermined number or less (NO), the processing proceeds to step S310 by the controller 9. Steps S33 to S310 are the same as steps S3 to S10 in FIG. 8.

The avatar control device 103 according to a third embodiment includes the avatar generator 7 which generates each avatar by drawing the avatar Av corresponding to each user, and the avatar motion setting unit 4 which sets a motion of each avatar based on a motion detection signal generated by the motion sensor 21 which acquires a motion of each user. When the number of avatars generated by the avatar generator 7 is more than a predetermined number, the avatar motion setting unit 4 sets an avatar whose motion magnitude is equal to or smaller than the predetermined magnitude to be in a stationary state, or to make a specific motion, regardless of the motion detection signal generated by the motion sensor 21. The magnitude of the specific motion is preferably smaller than the predetermined magnitude.

The avatar control method and the avatar control program according to a third embodiment are used to generate each avatar by drawing an avatar corresponding to each user, and set a motion of each avatar based on a motion detection signal generated by the motion sensor 21 which acquires a motion of each user. The avatar control method and the avatar control program according to a third embodiment are used to set an avatar corresponding to a user whose motion magnitude is equal to or smaller than the predetermined magnitude to be in a stationary state, or to make a specific motion, regardless of the motion detection signal generated by the motion sensor 21, when the number of generated avatars is more than the predetermined number.

Therefore, in accordance with the avatar control device 103, the avatar control method, and the avatar control program according to a third embodiment, it is possible to perform control so as to generate the avatar Av corresponding to each user, while preventing the drawing load or the communication load from becoming excessive. It is considered that an avatar whose motion magnitude is equal to or smaller than the predetermined magnitude makes a motion which is not so important. Therefore, even if the avatar is set to be in a stationary state, it is less likely that other users, other than a user corresponding to the avatar who is set to be in the stationary state, feel a sense of discomfort.

Regardless of whether the number of generated avatars is more than the predetermined number, the avatar control device 103, the avatar control method, and the avatar control program according to a third embodiment may set an avatar corresponding to a user whose motion magnitude is equal to or smaller than the predetermined magnitude to be in a stationary state, or to make a specific motion, regardless of the motion detection signal generated by the motion sensor 21.

### Fourth Embodiment

As shown in FIG. 9, each user terminal 20 includes an avatar control device 224 according to a fourth embodiment having the same configuration as the avatar control device 222. When the number of user terminals 20 connected to the avatar control server 10b is more than a predetermined number, the controller 9 in the avatar control server 10b instructs the user terminal 20 of a user corresponding to an avatar whose motion magnitude is equal to or smaller than a predetermined magnitude, not to transmit a skeletal motion signal transmitted from the user terminal 20 to the avatar control server 10b, based on the skeletal motion signal. The user terminal 20 which has been instructed by the controller 9 not to transmit the skeletal motion signal to the avatar control server 10b stops transmitting the skeletal motion signal to the avatar control server 10b.

An operation performed by the avatar control device 224 according to a fourth embodiment, an avatar control method according to a fourth embodiment, and an avatar control program according to a fourth embodiment are the same as those in FIG. 10.

The avatar control device 224 according to a fourth embodiment includes the avatar generator 207 which generates each avatar by drawing the avatar Av corresponding to each user, and the avatar motion setting unit 204 which sets a motion of each avatar based on a motion detection signal generated by the motion sensor 21 which acquires a motion of each user. When the number of avatars generated by the avatar generator 207 is more than a predetermined number, the avatar motion setting unit 204 sets an avatar whose motion magnitude is equal to or smaller than the predetermined magnitude to be in a stationary state, regardless of the motion detection signal generated by the motion sensor 21.

The avatar control method and the avatar control program according to a fourth embodiment are used to generate each avatar by drawing an avatar corresponding to each user, and set a motion of each avatar based on the motion detection signal generated by the motion sensor 21 which acquires a motion of each user. The avatar control method and the avatar control program according to a fourth embodiment are used to set an avatar corresponding to a user whose motion magnitude is equal to or smaller than the predetermined magnitude to be in a stationary state, regardless of the motion detection signal generated by the motion sensor 21, when the number of generated avatars is more than the predetermined number.

Therefore, in accordance with the avatar control device 224, the avatar control method, and the avatar control program according to a fourth embodiment, it is possible to perform control so as to generate the avatar Av corresponding to each user, while preventing the drawing load or the communication load from becoming excessive. It is considered that an avatar whose motion magnitude is equal to or smaller than the predetermined magnitude makes a motion which is not so important. Therefore, even if the avatar is set to be in a stationary state, it is less likely that other users, other than a user corresponding to the avatar who is set to be in the stationary state, feel a sense of discomfort.

Regardless of whether the number of generated avatars is more than the predetermined number, the avatar control device 224, the avatar control method, and the avatar control program according to a fourth embodiment may set an avatar corresponding to a user whose motion magnitude is equal to or smaller than the predetermined magnitude to be in a stationary state or to make a specific motion, regardless of the motion detection signal generated by the motion sensor 21.

The present invention is not limited to first to fourth embodiments described above, and various modifications are possible without deviating from the scope of the present invention.

The present invention based on first to fourth embodiments is set out in the appended set of claims. In addition, first to fourth embodiments disclose the following avatar control device.

(1) An avatar control device including:
an avatar generator configured to generate each avatar by drawing an avatar corresponding to each user; and
an avatar motion setting unit configured to set such that, when the number of the avatars generated by the avatar generator is more than a predetermined number, motions of some of the users selected based on the number of other avatars looking at an avatar in question are not reflected on the avatars.

(2) The avatar control device according to the above-described avatar control device of (1), wherein
a user terminal possessed by each user is configured to transmit, to the avatar control device, a motion detection signal generated by a motion sensor that detects a motion of each user, or a body motion signal indicating a motion of a body of each user generated based on the motion detection signal,
the avatar control device further comprises a controller configured to instruct user terminals of some of the users selected based on the number of other avatars looking at the avatar in question, not to transmit the motion detection signal or the body motion signal to the avatar control device, and
the avatar motion setting unit is configured to set such that motions of some of the users who possess the user terminals that have been instructed by the controller not to transmit the motion detection signal or the body motion signal to the avatar control device, are not reflected on the avatars.

(3) The avatar control device according to the above-described avatar control device of (1), wherein
the avatar control device is disposed in an avatar control server that is connected to a user terminal possessed by each user via a network,
each user terminal is configured to transmit, to the avatar control server, a motion detection signal generated by a motion sensor that detects a motion of each user, or a body motion signal indicating a motion of a body of each user generated based on the motion detection signal,
the avatar control device is configured to acquire the number of the user terminals connected to the avatar control server, and
the avatar control device further comprises a controller configured to instruct at least some of the user terminals, not to transmit the motion detection signal or the body motion signal to the avatar control server, when the number of the user terminals connected to the avatar control server is more than a predetermined number.

(4) The avatar control device according to the above-described avatar control device of (1), wherein
the avatar control device is disposed in each user terminal possessed by each user,
each user terminal is configured to transmit, to an avatar control server connected to each user terminal via a network, a body motion signal indicating a motion of a body of each user, generated based on a motion detection signal, that is generated by a motion sensor which detects a motion of a user possessing each user terminal,
each user terminal is configured to acquire the body motion signal generated by another user terminal other than a user terminal in question from the avatar control server, and
the avatar control device further comprises a controller configured to perform control to prevent the body motion signal from being transmitted to the avatar control server, when the number of the user terminals connected to the avatar control server is more than a predetermined number, and when the controller has received an instruction signal for instructing not to transmit the body motion signal to the avatar control server, that has been transmitted by the avatar control server.

(5) An avatar control device including:
an avatar generator configured to generate each avatar by drawing an avatar corresponding to each user;
an avatar motion setting unit configured to set whether to reflect a motion of each user on the avatar;
an off-tracking detector configured to detect an off-tracking state in which a motion detection signal corresponding to the motion of each user is no longer generated; and
a specific posture data holding unit configured to hold specific posture data for causing the avatar to be in a stationary state or causing the avatar to make a specific motion, wherein
among avatars corresponding to users in which the off-tracking state has been detected by the off-tracking detector, the avatar motion setting unit is configured to set an avatar in question who is looked at by a predetermined number or less of other avatars to be in the stationary state based on the specific posture data held in the specific posture data holding unit, and to set an avatar in question who is looked at by more than the predetermined number of other avatars to make a specific motion based on the specific posture data held in the specific posture data holding unit.

(6) An avatar control device including:
an avatar generator configured to generate each avatar by drawing an avatar corresponding to each user;
an avatar motion setting unit configured to set whether to reflect a motion of each user on the avatar;
an off-tracking detector configured to detect an off-tracking state in which a motion detection signal corresponding to the motion of each user is no longer generated; and
a specific posture data holding unit configured to hold specific posture data for causing the avatar to be in a stationary state or causing the avatar to make a specific motion, wherein
among avatars corresponding to users in which the off-tracking state has been detected by the off-tracking detector, the avatar motion setting unit is configured to set an avatar whose motion immediately before detection of the off-tracking state is equal to or smaller than a predetermined magnitude to be in the stationary state based on the specific posture data held in the specific posture data holding unit, and to set an avatar whose motion immediately before the detection of the off-tracking state is larger than the predetermined magnitude to make the specific motion based on the specific posture data held in the specific posture data holding unit.

What is claimed is:

1. An avatar control method comprising:
generating each avatar by drawing an avatar corresponding to each user; and
setting such that, when the number of the generated avatars is more than a predetermined number, motions of some of the users selected based on the number of other avatars looking at an avatar in question are not reflected on the avatars.

2. An avatar control method comprising:
generating each avatar by drawing an avatar corresponding to each user;
setting whether to reflect a motion of each user on the avatar;
detecting an off-tracking state in which a motion detection signal corresponding to the motion of each user is no longer generated;
holding specific posture data for causing the avatar to be in a stationary state or causing the avatar to make a specific motion in a specific posture data holding unit;
among avatars corresponding to users in which the off-tracking state has been detected, setting an avatar in question who is looked at by a predetermined number or less of other avatars to be in the stationary state based on the specific posture data held in the specific posture data holding unit; and,
among avatars corresponding to users in which the off-tracking state has been detected, setting an avatar in question who is looked at by more than the predetermined number of other avatars to make a specific motion based on the specific posture data held in the specific posture data holding unit.

3. An avatar control method comprising:
generating each avatar by drawing an avatar corresponding to each user;
setting whether to reflect a motion of each user on the avatar;
detecting an off-tracking state in which a motion detection signal corresponding to the motion of each user is no longer generated;
holding specific posture data for causing the avatar to be in a stationary state or causing the avatar to make a specific motion in a specific posture data holding unit;
among avatars corresponding to users in which the off-tracking state has been detected, setting an avatar whose motion immediately before detection of the off-tracking state is equal to or smaller than a predetermined magnitude to be in the stationary state based on the specific posture data held in the specific posture data holding unit; and
among avatars corresponding to users in which the off-tracking state has been detected, setting an avatar whose motion immediately before the detection of the off-tracking state is larger than the predetermined magnitude to make the specific motion based on the specific posture data held in the specific posture data holding unit.
